(19) United States
(12) Patent Application Publication
(10) Pub. No.: US 2020/0239229 A1
(43) Pub. Date: Jul. 30, 2020

(54) Systems and Methods for Object Storage and Retrieval

(71) Applicant: Walmart Apollo, LLC, Bentonville, AR (US)

(72) Inventors: David G. Tovey, Rogers, AR (US); Kurt William Robert Bessel, Mexico, NY (US)

(21) Appl. No.: 16/530,390

(22) Filed: Aug. 2, 2019

Related U.S. Application Data
(60) Provisional application No. 62/713,697, filed on Aug. 2, 2018.

(51) Int. Cl. B65G 1/04; B65G 1/06

(52) U.S. Cl. CPC B65G 1/045; B65G 1/06

(57) ABSTRACT

A storage tower can be configured to store and dispense physical objects. The storage tower includes a first vertical shaft disposed in the central vertical cavity of the storage tower. The storage tower further includes a first transport apparatus operatively coupled to the first vertical shaft. The storage tower further includes a second vertical shaft disposed within the vertical central cavity of the storage tower. A second transport apparatus can be operatively coupled to the second vertical shaft. A first pair of rotatable plates can be disposed in an upper portion of the central cavity. A second pair of rotatable plates can be disposed in a lower portion of the central cavity.

### RELATED APPLICATIONS

The present application claims priority to and the benefit of U.S. Provisional Application No. 62/713,697, filed on Aug. 2, 2018, the content of which is incorporated by reference herein in its entirety.

### BACKGROUND

Physical objects can be stored and later retrieved by autonomous storage and retrieval systems for users. Storage and retrieval of physical objects in these autonomous storage and retrieval systems can be slow and inefficient.

### BRIEF DESCRIPTION OF DRAWINGS

Illustrative embodiments are shown by way of example in the accompanying drawings and should not be considered as a limitation of the present disclosure:

FIGS. 1A-B are schematic diagrams of a storage tower in accordance with an exemplary embodiment;

FIG. 2 is a schematic diagram a receptacle in accordance with an exemplary embodiment;

FIG. 3 is a schematic diagram of the exterior of the storage tower in accordance with an exemplary embodiment;

FIG. 4 is a block diagram illustrating an autonomous object storage and retrieval system in accordance with an exemplary embodiment;

FIG. 5 is a block diagram illustrating of an exemplary computing device in accordance with an exemplary embodiment;

FIG. 6 is a flowchart illustrating an exemplary process in accordance with an exemplary embodiment, and

FIG. 7 is a flowchart illustrating an exemplary process in accordance with an exemplary embodiment.

### DETAILED DESCRIPTION

Described in detail herein is an autonomous object storage and retrieval system. A storage tower can be configured to store and dispense physical objects. The storage tower can include shelves disposed within the storage tower about a perimeter of an inner wall of the storage tower defining a central vertical cavity. The shelves can be configured to support the physical objects. The storage tower can include one or more receptacles for receiving the physical objects to be stored by the storage tower or for outputting the physical objects from the storage tower. The one or more receptacles form one or more openings in wall(s) of the storage tower.

The storage tower can include a first vertical shaft disposed in the central vertical cavity of the storage tower, and can include a first transport apparatus operatively coupled to the first vertical shaft. The first transport apparatus can be configured to traverse the shaft to transport the physical objects to and from the one or more receptacles to the shelves. The storage tower further includes a second vertical shaft disposed within the vertical central cavity of the storage tower. The second vertical shaft can extend parallel to the first vertical shaft. A second transport apparatus can be operatively coupled to the second vertical shaft, and can be configured to traverse the second vertical shaft to transport the physical objects to and from the one or more receptacles to the shelves.

A first pair of rotatable plates or supports can be disposed in an upper portion of the central cavity. The first vertical shaft can be operatively coupled to a first plate in the first pair of rotatable plates and the second vertical shaft can be operatively coupled to a second plate in the first pair of rotatable plates. A second pair of rotatable plates can be disposed in a lower portion of the central cavity. The first vertical shaft being operatively coupled to a third plate in the second pair of rotatable plates and the second vertical shaft being operatively coupled to a fourth plate in the second pair of rotatable plates.

The first through fourth rotatable plates are circular members concentrically aligned about a rotational axis. The first and third plates are configured to synchronously rotate about the rotational axis and the second and fourth plates are configured to synchronously rotate about the rotational axis. The first and third plates are independently rotatable relative to second and fourth plates. The first and second transport apparatuses can operate independently of each other.

The one or more receptacles can include a first receptacle and a second receptacle. The one or more openings include a first opening formed by the first receptacle and a second opening formed by the second receptacle. The first receptacle and the first opening can be disposed on the upper half of the storage tower and the second receptacle and the second opening can be disposed on lower half of the storage tower. In some embodiments, the first transport apparatus can traverse the first vertical shaft in the upper half or three quarters of the storage tower and the second transport apparatus can traverse the second vertical shaft in the lower half or three-quarters of the storage tower such that the first and second transport apparatuses can operate in exclusive areas of the central cavity and/or can operate in overlapping areas of the central cavity. In some embodiments, the first transport apparatus and the second transport apparatus can traverse the first and second shafts, respectively, along a length of the shaft (e.g., from the lower portion of the cavity to the upper portion of the cavity).

A computing system is in communication with the storage tower. The computing system can receive a first request from the storage tower, for retrieval of a first physical object stored in the storage tower, through the first opening. The computing system can receive a second request from the storage tower to receive a second physical object for storage in the storage tower, through the second opening in the second receptacle. The computing system can instruct the first transport apparatus to transport the first physical object from at least one shelves of the shelving unit to the first receptacle. The computing system can instruct the second transport apparatus to transport the second physical object from the second receptacle to at least one of the shelves of the shelving unit for storage.

The first vertical shaft is disposed a first radial distance from the rotational axis and the second vertical shaft is disposed at a second radial distance from the rotational axis. The first and second transport apparatuses extend radially from the first and second vertical shafts, respectively. The first and second transport apparatuses each are rotatable by the first and second vertical shaft, respectively to have three hundred sixty degree access to the shelves disposed about the central cavity.

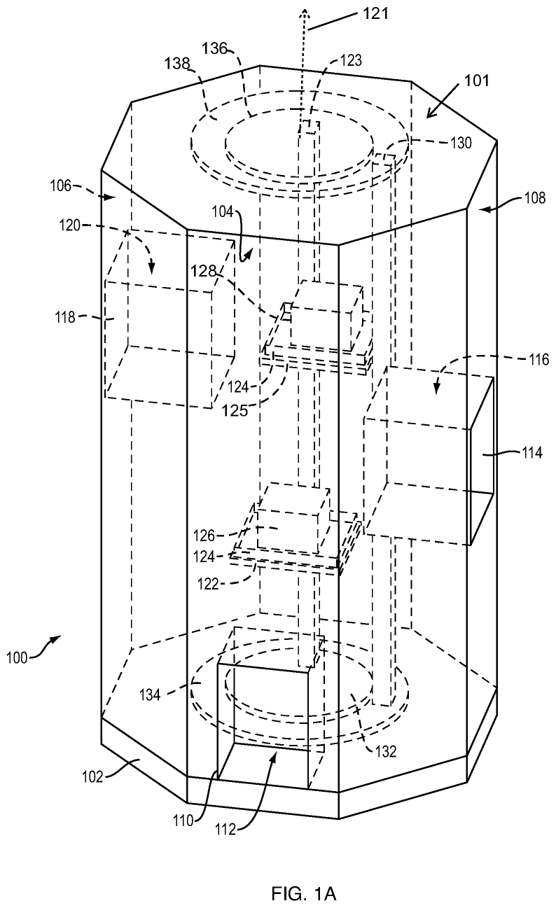

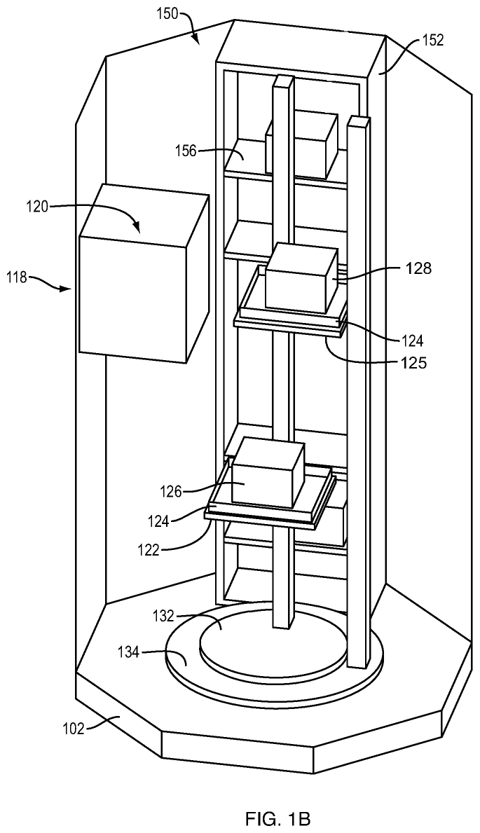

FIGS. 1A-B is a block diagram of an exemplary storage tower 100 in accordance with an exemplary embodiment. The storage tower 100 can include a base 102 coupled to a housing including eight side wall surfaces extending generally vertically from the base 102. The surfaces can include a front face 104, a first side face 106, and a second side face 108. A front opening 110 can be disposed on the front face 104. A first side opening 118 can be disposed on the first side face 106. A second side opening 114 can be disposed on the second side face 108. The openings, e.g., front opening 110, first side opening 118, and second side openings 114, can be retractable doors, windows, or panels.

An interior of the storage tower 100 can include a central cavity 101. The central cavity 101 can include first transport apparatus 122 coupled to first vertical shaft 123 and a second transport apparatus 125 coupled to a second vertical shaft 130. The first and second vertical shaft 123, 130 can be embodied as railings or a boom. The first vertical shaft 123 is disposed at a first radial distance from a rotational axis 121 and the second vertical shaft 130 is disposed at a second radial distance from the rotational axis 121. The first and second transport apparatuses 122, 125 can extend radially from the first and second vertical shafts 123 and 130, respectively. The first and second transport apparatuses 122, 125 each are rotatable by the first and second vertical shaft, respectively to have three hundred sixty degree access to shelving units disposed about the central cavity 101. The shelving units will be described in greater detail with respect to FIG. 1B.

The central cavity 101 of the storage tower can further include a first pair of plates including first and second rotatable plates 132, 134 disposed on the base 102 of the storage tower 100 and a second pair of rotatable plates including a third and fourth rotatable plates 136, 138 disposed on the top of the storage tower 100. The first vertical shaft 123 can be operatively coupled to the first rotatable plate 132 in the first pair of rotatable plates and the second vertical shaft 130 can be operatively coupled to a second rotatable plate 134 in the first pair of rotatable plates. The first vertical shaft 123 can be operatively coupled to a third rotatable plate 136 in the second pair of rotatable plates and the second vertical shaft 130 can be operatively coupled to a fourth plate 138 in the second pair of rotatable plates.

The first through fourth rotatable plates 132-138 can be circular members concentrically aligned about the rotational axis. In exemplary embodiments, the rotational axis 121 can correspond to a center axis of the first through fourth plates 132-138, can correspond to a center axis of the interior cavity 101, and/or can correspond to a center axis of the storage tower 100. The first and third plates 132, 136 are configured to synchronously rotate and the second and fourth plates 134, 138 are configured to synchronously rotate. The first and third plates 132, 136 are independently rotatable from second and fourth plates 134, 138. The first and second transport apparatuses 122, 125 operate independently of each other. The first through fourth rotatable plates 132-138 can be configured to rotate the first and second vertical shafts 123, 130 360 degrees, within the central cavity 101 of the storage tower 100.

In one example, the first and second transport apparatus 122 and 125 can rotate circumferentially around the first and second shaft 123 and 130 respectively. As a non-limiting example, the second transport apparatus 125 can face away from the second side receptacle 116 and can rotate around the second shaft 130 so that the second transport apparatus 125 is rotated at an orientation for interfacing with the second side receptacle 116 to deposit/retrieve the tray 124 and physical object 126 in the second storage receptacle 116.

The first transport apparatus 122 can be configured to transport and support a tray 124 which is configured to support a first physical object 126. The second transport apparatuses 125 can be configured to transport and support a tray 124 which is configured to support a second physical object 128. The first and second transport apparatuses 122, 125 are further configured traverse along the first and second vertical shafts along the rotational axis 121. The central cavity 101 of the storage tower 100 can further include front receptacle 112 aligned with and/or coupled to the front opening 110. A first side receptacle 120 can be aligned with and/or coupled to the first side opening 118. A second side receptacle 116 can be aligned with and/or coupled to the second side opening 114. The front receptacle 112, first side receptacle 120, and second side receptacle 116 can include a storage volume, configured to store objects, such as the tray 124 and the first or second physical objects 126, 128. The front opening 110, first side opening 118, and second side opening 114 can provide access to the storage volume of the front receptacle 112, first side receptacle 120, and second side receptacle 116, respectively. In one embodiment, the first side opening and receptacle 118, 120 can be disposed in an upper portion of the storage tower 100, while the second side opening and receptacle 114, 116 can be disposed in a lower portion of the storage tower 100. It can be appreciated, the first and second opening and receptacles can be disposed one any face at any position of the storage tower 100. As a non-limiting example, the first side opening 118 can be aligned to an opening of a retail store, warehouse, and/or any other building and can be configured to receive physical object for loading the storage tower 100.

With reference to FIG. 1B, the interior of the storage tower 100 can include eight interior walls 150 defined by the housing. The interior of the storage tower 100 can include a shelving unit 152. The shelving unit 152 can include shelves 156 configured to store and support physical objects including the first and second physical objects 126 and 128. The shelving unit 152 can be disposed along one or more of the interior walls 150 of the storage tower 100. For example, the shelving units 152 can be disposed along one interior wall, each interior wall or a subset of the interior walls 150 of the storage tower 100.

With reference to FIGS. 1A and 1B, in an exemplary operation, the storage tower 100 can receive a request to retrieve and dispense the first physical object 126 through the front opening 110. Simultaneously, the storage tower 100 can receive a request to receive and store a second physical object 128 through the second side opening 114. The storage tower 100 can receive the second physical object 128 through the second side opening 114 into the second side receptacle 116. The storage tower 100 can control the operation of the first and third rotatable plates 132, 136 to rotate the first vertical shaft 123 in a clockwise and/or counter clockwise direction around the rotational axis 121 and the first transport apparatus 122 can rotate about and traverse up and/or down the first vertical shaft 123 so that the first transport apparatus 122 is rotated at an orientation for interfacing with a shelf 156 storing the first physical object 126. The first transport apparatus 122 can pick-up the tray 124 supporting the first physical object 126. The storage tower 100 can control the operation of the first and third rotatable plates 132, 136 to rotate the first vertical shaft 123 in a clockwise and/or counter clockwise direction around rotational axis and the first transport apparatus 122 can rotate about and traverse up and/or down the first vertical shaft 123 so that transport apparatus 122 is rotated at an orientation for interfacing with the front receptacle 112. The first transport apparatus 122 can deposit the tray 124 supporting the first physical object 126 in the front receptacle 112. The tray 124 supporting the first physical object 126 can be ejected through the front opening 110.

Additionally, the storage tower 100 can control the operation of the second and fourth rotatable plates 134, 138 to rotate the second vertical shaft 130 in a clockwise and/or counter clockwise direction around the rotational axis 121 and the second transport apparatus 125 can rotate about and traverse up and/or down the second vertical shaft 130 so that the second transport apparatus 125 is rotated at an orientation for interfacing with the second side receptacle 116 in which the second physical object 128 is disposed. The second physical object 128 can be disposed in the second side receptacle 116 on a tray 124. The second transport apparatus 125 can pick-up the tray 124 supporting the second physical object 128 from the second side receptacle 116. The storage tower 100 can control the operation of the second and fourth rotatable plates 134, 138 to rotate the second vertical shaft 130 in a clockwise and/or counter clockwise direction around the rotational axis and the second transport apparatus 125 can rotate about and traverse up and/or down the second vertical shaft 130 so that the second transport apparatus 125 coupled to the second vertical shaft 130 is rotated at an orientation for interfacing with the shelving unit 152. The second transport apparatus 125 can deposit the tray 124 supporting the second physical object 128 onto a shelf 156 of the shelving unit 152.

In one embodiment, the storage tower 100 can control the operation of the first and third rotatable plates 132, 136, second and fourth rotatable plates to rotate the 134, 138, and the first and second transport apparatuses 122 and 125 to avoid any possible collisions. For example, the storage tower 100 can determine the location of the first and second shafts 123 and 130 and the location of the first and second transport apparatuses 122 and 125. Based on the location of the first and second shafts 123 and 130 the location of the first and second transport apparatuses 122 and 125, the storage tower can 100 can determine and instruct a rotational path of the first and third rotatable plates 132, 136, the second and fourth rotatable plates to rotate the 134, 138, and/or the first and second transport apparatuses 122 and 125. The storage tower 100 can control the operation of the first and third rotatable plates 132, 136, second and fourth rotatable plates to rotate the 134, 138, and the first and second transport apparatuses 122 and 125, to execute the rotational path when retrieving or depositing physical objects (i.e., first and second physical objects 126 and 128) in the respective storage receptacles. The rotational path can include instructions for rotating a specified direction and/or rotating at a specified speed. The rotational path can also include instructions for the first and second transport apparatuses 122 and 125 to traverse a specified length along the first and second shafts 123 and 130. The rotational path can also include instructions for the first and second transport apparatuses 122 and 125 to fold up or down when passing each other. In one embodiment, while a transport apparatus (i.e. first or second transport apparatus 122 and 125) is not in use, the storage tower 100 can instruct the transport apparatus to fold up or down.

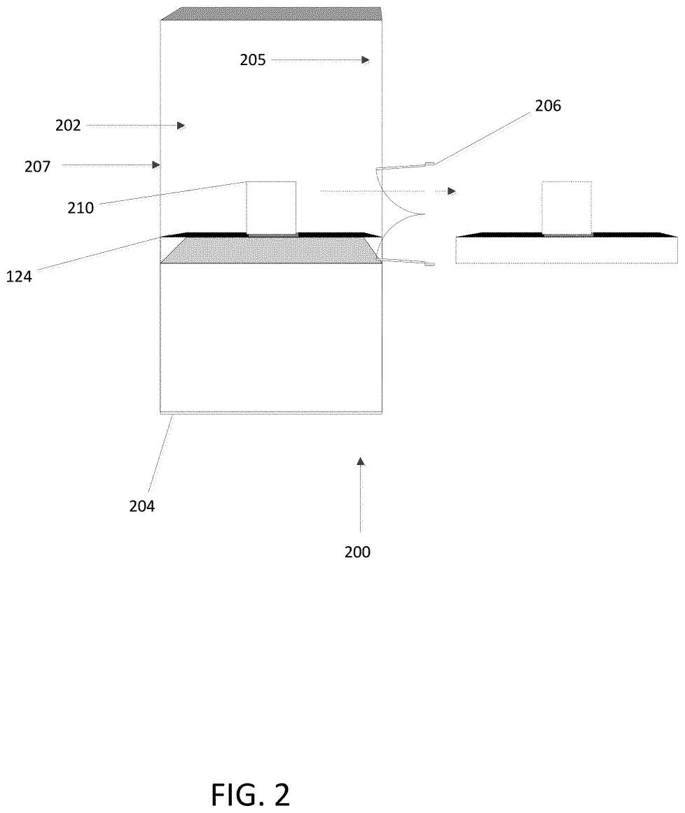

FIG. 2 is a block diagram of a receptacle 200 in accordance with exemplary embodiments. As described above, a storage tower can include a front, first side, and second side receptacle. The receptacle 200 can be embodied as the front, first side and/or second side receptacle. The receptacle 200 can include an interior storage volume 202 and a base 204. The base 204 can support a tray 124, which can support a physical object 210. The front side 205 of the receptacle 200 can include a door 206. The back side 207 of the receptacle 200 can be an open face. The receptacle 200 can be configured to receive and eject the tray 124 and physical object 210 from the door 206 on the front side and through the open face of the back side 207. The door can be a sliding door (sliding horizontally or vertically), a rotating door, a hinged door, and/or a double door.

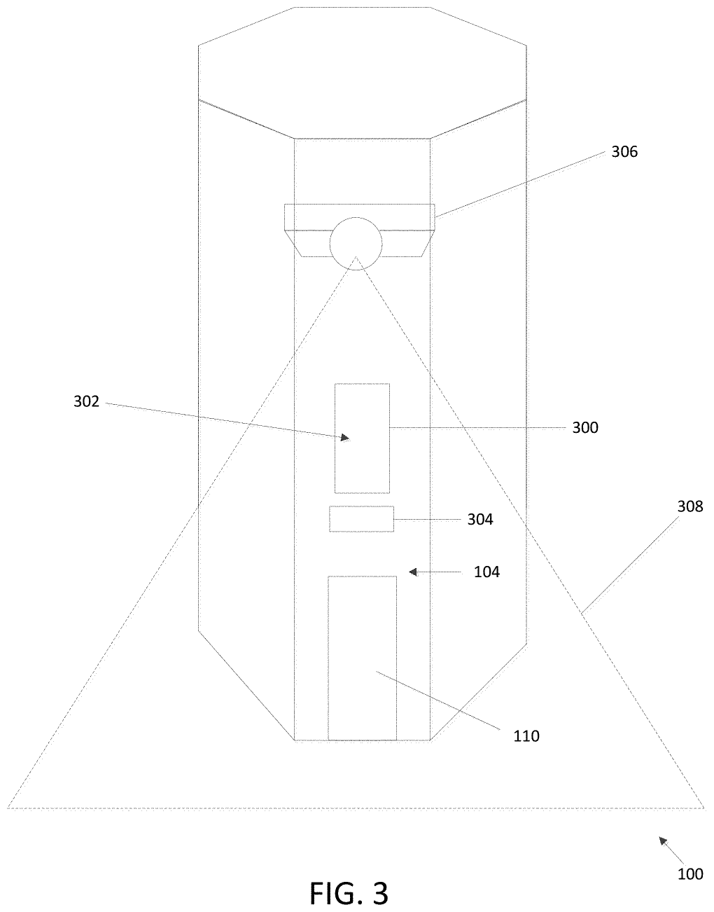

FIG. 3 is a schematic diagram of an exterior of an embodiment of the storage tower 100 in accordance with an exemplary embodiment. An interactive display 300 can be disposed on the storage tower 100. The interactive display 300 can be disposed on the front surface 104 with respect to the front opening. An input device 304 can also be disposed on the storage tower. The input device 304 can be disposed on the front surface 104 with respect to the front opening 110. The input device 304 can be one or more of, an optical scanner, a keyboard/keypad, and image capturing device.

The interactive display 300 can render a graphical user interface (GUI) 302. The GUI 302 can display information associated with a request for dispensing a physical object through the front opening of the storage tower. As an example, a user can input information associated with a request for dispensing a physical object. The information can be an identifier, a name, a username, a pin number or any suitable information that can be used to identify the physical object to be retrieved or stored. As a non-limiting example, the user can enter the information, via a touchscreen display incorporated in the interactive display 300. Alternatively, or in addition to, the interactive display 300 can have multiple input devices such as a keyboard, mouse, joystick, touchpad, or other devices configured to interact with the interactive display 300, such as the input device 304. The user can input identification information using the input device 304

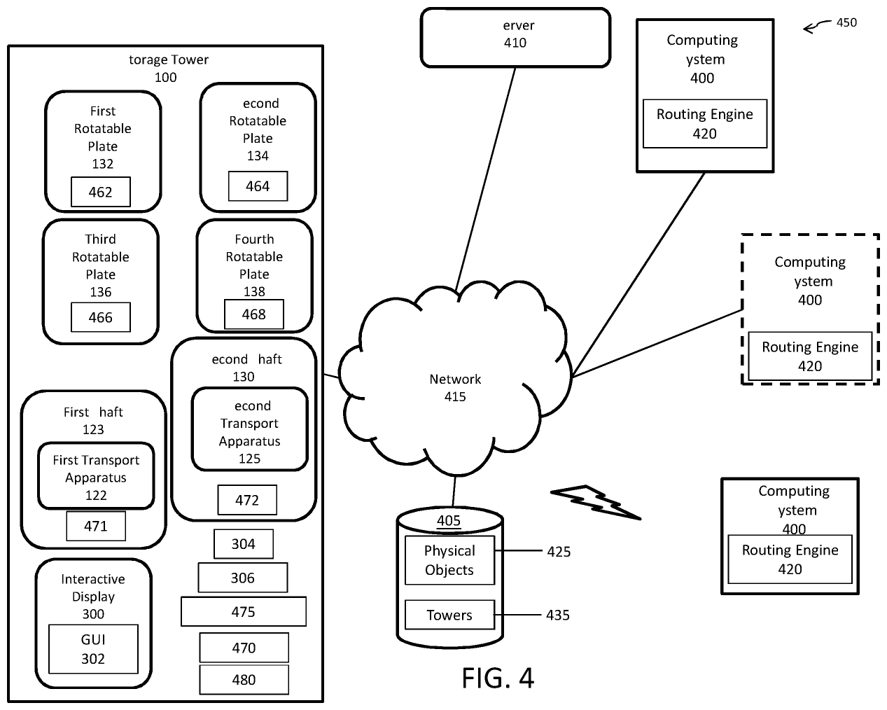

The user can also scan a machine-readable element encoded with an identifier associated with the physical object, using the input device 304. As an example, the input device 304 can be an optical scanner or an image capturing device. The input device 304 can scan/capture and decode the identifier from the machine-readable element. The machine-readable element can be a barcode or a QR code. The input device 304 can transmit the identifier to the interactive display. The interactive display 300 can receive the information associated with the request and transmit the information to a computing system. The computing system will be described in greater detail with respect to FIG. 4.

In one embodiment, a motion sensor 306 can be disposed on the front surface 104 of the storage tower 100. The motion sensor can detect a user approaching the storage tower 100, within a given radius 308. The doors of the front opening 110 can automatically open in response to the motion sensor 306 detecting a user approaching the storage tower 100. Alternatively, or in addition to, the interactive display 300 can be powered down (in energy saving mode) and in response to the motion sensor detecting a user entering the radius 308, the interactive display 300 can be powered on.

In one embodiment, the user can request to dispense a physical object, disposed in the storage tower 100 or another storage tower. The user can input identification information associated with the using the interactive display 300 and/or input device 304. The identification information can be transmitted to the computing system. The computing system can instruct the storage tower 100 in which the physical object is disposed to dispense the physical object. In the event the physical object is disposed in the storage tower 100, the storage tower 100 can dispense the physical object through the front opening 110 of the storage tower 100.

FIG. 4 illustrate an exemplary autonomous object storage and retrieval system 450 in accordance with an exemplary embodiment. The autonomous object storage and retrieval system 450 can include one or more databases 405, one or more servers 410, one or more computing systems 400, and one or more storage towers 100. The computing system 400 can include a routing engine 420. The routing engine 420 can implement the autonomous object storage and retrieval system 450.

In an example embodiment, one or more portions of the communications network 415 can be an ad hoc network, a mesh network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a Wi-Fi network, a WiMAX network, any other type of network, or a combination of two or more such networks.

The server 410 includes one or more computers or processors configured to communicate with the computing system 400, the databases 405, and the storage towers 100, via a communications network 415. The server 410 hosts one or more applications configured to interact with one or more components computing system 400 and/or facilitates access to the content of the databases 405. The databases 405 may store information/data, as described herein. For example, the databases 405 can include physical objects database 425 and a towers database 435. The physical objects database 425 can store information associated with physical objects. The towers database 435 can store information associated with the storage towers location and physical object disposed in the storage towers. The databases 405 can be located at one or more geographically distributed locations from the computing system 400. Alternatively, the databases 405 can be located at the same geographically as the computing system 400.

The storage towers 100 can include a first transport apparatus 122 coupled to a first vertical shaft 123, a second transport apparatus 125 coupled to a second vertical shaft 130, a controller 470, and a transceiver 475. The first vertical shaft 123 can be coupled to the first rotatable plate 132 disposed at the bottom of the storage tower 100 and the third rotatable plate 136 disposed at the top of the storage tower 100. The second vertical shaft 130 can be coupled to the second rotatable plate 134 disposed at the bottom of the storage tower and the fourth rotatable plate 138 disposed at the top of the storage tower 100. The storage tower 100 can also include an interactive display 300 including a GUI 302, an input device 304, and a sensor 306. The storage towers 100 can also be coupled to a power source 480. The power source 480 can provide power to the controller 470, transceiver 475, first transport apparatus 122, second transport apparatus 125, the first through fourth rotatable plates 132-138, the interactive display 300, input device 304, and the sensor 306. The transceiver 475 can be configured to receive and transmit data, via the network 415. The controller 470 can control the operations of the first transport apparatus 122, second transport apparatus 125, the first through fourth rotatable plates 132-138, the interactive display 300, input device 304, and the sensor 306, based on received data from the transceiver 475.

The first and second rotatable plates 132-134 can each be coupled to a motor 462-464 to rotatably drive the plates 132-134, while the plates 136-138 can freely rotate such that the third and fourth rotatable plates 136-138 can rotate in response to the rotation of the first and second rotatable plates 132-134, respectively. As another example, the third and fourth rotatable plates 136-138 can each be coupled to a motor 466-468 to rotatably drive the plates 136-138, while the plates 132-134 can freely rotate such that the third and fourth rotatable plates 136-138 can rotate in response to the rotation of the first and second rotatable plates 132-134, respectively. As another example, the first and fourth rotatable plates 132 and 138 can each be coupled to the motor 462 and 468, respectively, to rotatably drive the first and fourth rotatable plates 132 and 138, while the second and third rotatable plates 134-136 can freely rotate such that the second and third rotatable plates 134-136 can rotate in response to the rotation of the first and fourth rotatable plates 132 and 138, respectively. As another example, the second and third rotatable plates 134 and 136 can each be coupled to the motor 464 and 466, respectively, to rotatably drive the second and third rotatable plates 134 and 136, while the first and fourth rotatable plates 132 and 138 can freely rotate such that the first and fourth rotatable plates 132 and 138 can rotate in response to the rotation of the second and third rotatable plates 134 and 136, respectively. As another example, the first through fourth rotatable plates 132-138 can be coupled to the motors 462-468, respectively. It can be appreciated that the power source 480 can supply power to the motors 462, 464, 466, and/or 468. The controller 470 can actuate the motors 462, 464, 466, and/or 468 to cause the first through fourth rotatable plates 132-138 to rotate in either direction. As an example, the motors 462-466 can include gears to rotate the first through fourth rotatable plates 132-138. The first and second transport apparatuses 122 and 125 can include actuating devices 471 and 472. The controller 470 can actuate the actuating devices 471 and 472 to cause the first and second transport apparatuses 122 and 125 to traverse up and down or rotate about the first and second shaft 123 and 130. As a non-limiting example, the actuating devices 471 and 472 can be motors, hydraulic system, or a chain drive system.

In an exemplary embodiment, the storage tower 100 can receive a first request, via the interactive display 300 and/or input device 304, to retrieve and dispense a first physical object (e.g., first physical object 126 as shown in FIGS. 1A-1B) stored in the storage tower 100. Serially or concurrently, the storage tower 100 can receive a second request, via the interactive display 300 and/or input device 304, to receive and store a second physical object (e.g., second physical object 128 as shown in FIGS. 1A-B). The first and second request can include identification information associated with the first and second physical object. The storage tower 100 can transmit, via the transceiver 475, the identification information associated with the first and second physical object to the computing system 400.

The computing system 400 can execute the routing engine 420 in response to receiving the identification information associated with the first and second physical objects. The routing engine 420 can query the physical objects database 425 to retrieve information associated with the first and second physical objects and the routing engine 420 can query the towers database 435 to retrieve information associated with the storage tower 100. As an example, the routing engine 420 can retrieve information associated with the physical objects stored in the storage tower 100, and/or the rotatable plates to which power is supplied, the location of the transport apparatuses (i.e., in the lower or higher location within the storage tower). The routing engine 420 can determine from which opening (i.e., front, first side and second side openings 110, 118, 114 as shown in FIGS. 1A-B) of the storage tower 100 can the first physical object be output and from which opening can the second physical object be received. The routing engine 420 can also determine which transport apparatus can retrieve and dispense the first physical object and which transport apparatus can receive and store the second physical object. Additionally, the routing engine 420 can determine which rotatable plates are coupled to which shafts. As a non-limiting example, the routing engine 420 can determine the first transport apparatus 122 can retrieve and dispense the first physical object and the second transport apparatus 125 can receive and store the second physical object.

As a non-limiting example, the front opening of the storage tower can be disposed at the lower end of the storage tower 100, the first side opening can be disposed towards the top end of the storage tower 100 and the second side opening can be disposed toward the middle of the storage tower 100. In addition to or in an another non-limiting example, the first vertical shaft 123 and first transport apparatus 122 can be configured to receive and dispense physical objects in the lower end or middle of the storage tower 100, while the second vertical shaft 130 and second transport apparatus 125 can be configured to receive and dispense physical objects in the top end of the storage tower 100. Alternatively, the first vertical shaft 123 and first transport apparatus 122 can be configured to dispense physical objects, while the second vertical shaft 130 and second transport apparatus 125 can be configured to receive physical objects. Alternatively, the first vertical shaft 123 and first transport apparatus 122 and the second vertical shaft 130 and second transport apparatus 125 can be configured to dispense and receive physical objects from any opening in the storage tower 100.

Continuing with the earlier example, the routing engine 420 can instruct the controller 470 of the storage tower 100, via the transceiver 475, control the first transport apparatus 122 to retrieve and dispense the first physical object at an identified opening and the second transport apparatus 125 to receive and store the second physical object at a different identified opening. The controller 470 can control the operation of the first and third rotatable plates 132, 136 to rotate the first vertical shaft 123 in a clockwise and/or counter clockwise direction around a center axis and the first transport apparatus 122 can traverse up and/or down the first vertical shaft 123, so that the first transport apparatus 122 is rotated at an orientation for interfacing with first physical object stored within the storage tower (e.g., on a shelving unit 152 as shown in FIG. 1B). The first transport apparatus 122 can transport a tray (e.g., tray 124 as shown in FIGS. 1A-1B) supporting the first physical object. The controller 470 can control the operation of the first and third rotatable plates 132, 136 to rotate the to rotate the first vertical shaft 123 in a clockwise and/or counter clockwise direction around a center axis and the first transport apparatus 122 can traverse up and/or down the first vertical shaft 123 so that the first transport apparatus 122 is rotated at an orientation for interfacing with a receptacle (e.g., front, first side, or second side receptacles 112, 120, 116) coupled to the identified opening. The first transport apparatus 122 can deposit the tray supporting the first physical object in the receptacle coupled to the identified opening. The tray supporting the first physical object can be ejected through the identified opening.

Additionally, the controller 470 can control a receptacle coupled to the different identified opening to receive the second physical object. The controller 470 can control the operation of the second and fourth rotatable plates 134, 138 to rotate the second vertical shaft 130 in a clockwise and/or counter clockwise direction around a center axis and the second transport apparatus 125 can traverse up and/or down the second vertical shaft 130 so that the second transport apparatus 125 is rotated at an orientation for interfacing with a receptacle coupled to the different opening, in which the second physical object has been received. The second transport apparatus 125 can pick-up the tray supporting the second physical object from the receptacle. The storage tower 100 can control the operation of the second and fourth rotatable plates to rotate the 134, 138 to rotate the second vertical shaft 130 in a clockwise and/or counter clockwise direction around a center axis and the second transport apparatus 125 can traverse up and/or down the second vertical shaft 130 so that the second transport apparatus 125 is rotated at an orientation for interfacing with a shelving unit (e.g., shelving unit 152 as shown in FIG. 1B) disposed within the storage tower 100. The second transport apparatus 125 can deposit the tray supporting the second physical object onto a shelf (e.g., shelf 156 as shown in FIG. 1B) of the shelving unit.

As a non-limiting example, the autonomous storage and retrieval system 450 can be implemented in a retail store. The storage tower 100 can be dispensed inside or outside a retail store or warehouse. The physical object can be products purchased or about to be purchased by users from the retail store and/or stocked by the retail store/warehouse. The user can be a customer of the retail store and can pick-up products from the storage towers. Alternatively or in addition to, the user can be retail store/warehouse associates stocking the products in the storage tower 100. As an example, the user such as a can purchase something online and pick-up the product from the storage tower 100. Alternatively, or in addition to, the user can use the interactive display 300 of the storage towers 100 and/or a Point-of-Sale (POS) terminal of the retail store to purchase a product and pick-up the product from the storage towers 100. As described above, the user can request the physical object from any of the storage towers 100. Additionally, a retail store/warehouse such as a customer and/or store associate can request to store something in the storage tower 100 (e.g., stocking or initiating a return). The user can use the interactive display 300 and/or input device 304 of the storage towers 100 to initiate the request.

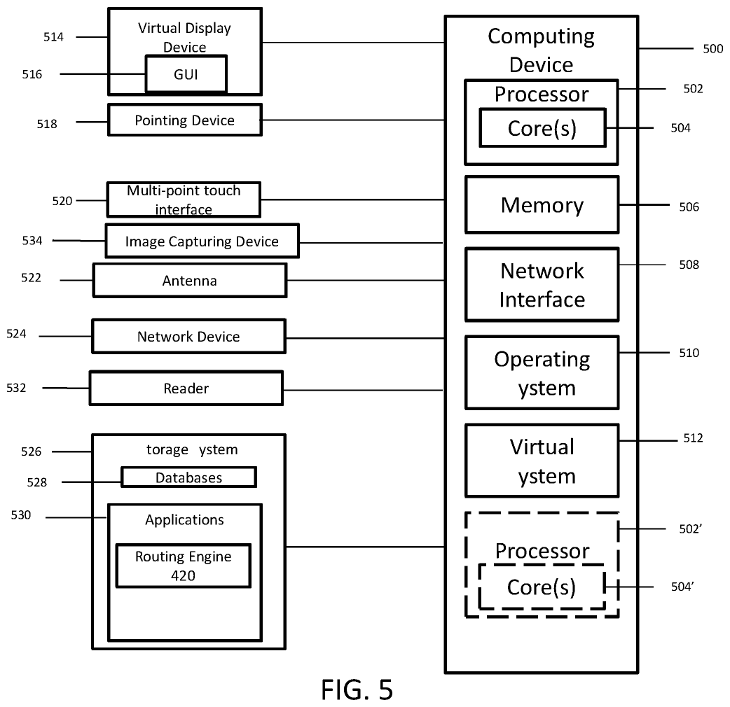

FIG. 5 is a block diagram of an example computing device for implementing exemplary embodiments of the present disclosure. The computing device 500 may be, but is not limited to, a smartphone, laptop, tablet, desktop computer, server or network appliance. The computing device 500 can be embodied as part of the computing system or storage tower. The computing device 500 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 506 included in the computing device 500 may store computer-readable and computer-executable instructions or software (e.g., applications 530 such as the routing engine 420) for implementing exemplary operations of the computing device 500. The computing device 500 also includes configurable and/or programmable processor 502 and associated core(s) 504, and optionally, one or more additional configurable and/or programmable processor(s) 502′ and associated core(s) 504′ (for example, in the case of computer systems having multiple processors/cores), for executing computer-readable and computer-executable instructions or software stored in the memory 506 and other programs for implementing exemplary embodiments of the present disclosure. Processor 502 and processor(s) 502′ may each be a single core processor or multiple core (504 and 504′) processor. Either or both of processor 502 and processor(s) 502′ may be configured to execute one or more of the instructions described in connection with computing device 500.

Virtualization may be employed in the computing device 500 so that infrastructure and resources in the computing device 500 may be shared dynamically. A virtual machine 512 may be provided to handle a process running on multiple processors so that the process appears to be using only one computing resource rather than multiple computing resources. Multiple virtual machines may also be used with one processor.

Memory 506 may include a computer system memory or random access memory, such as DRAM, SRAM, EDO RAM, and the like. Memory 506 may include other types of memory as well, or combinations thereof.

A user may interact with the computing device 500 through a visual display device 514, such as a computer monitor, which may display one or more graphical user interfaces 516, multi touch interface 520, a pointing device 518, an image capturing device 534 and a scanner 532.

The computing device 500 may also include one or more computer storage devices 526, such as a hard-drive, CD-ROM, or other computer-readable media, for storing data and computer-readable instructions and/or software that implement exemplary embodiments of the present disclosure (e.g., applications). For example, exemplary storage device 526 can include one or more databases 528 for storing information regarding physical objects and the storage towers. The databases 528 may be updated manually or automatically at any suitable time to add, delete, and/or update one or more data items in the databases.

The computing device 500 can include a network interface 508 configured to interface via one or more network devices 524 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 522 to facilitate wireless communication (e.g., via the network interface) between the computing device 500 and a network and/or between the computing device 500 and other computing devices. The network interface 508 may include a built-in network adapter, network interface card, PCMCIA network card, card bus network adapter, wireless network adapter, USB network adapter, modem or any other device suitable for interfacing the computing device 500 to any type of network capable of communication and performing the operations described herein.

The computing device 500 may run any operating system 510, such as versions of the Microsoft® Windows® operating systems, different releases of the Unix and Linux operating systems, versions of the MacOS® for Macintosh computers, embedded operating systems, real-time operating systems, open source operating systems, proprietary operating systems, or any other operating system capable of running on the computing device 500 and performing the operations described herein. In exemplary embodiments, the operating system 510 may be run in native mode or emulated mode. In an exemplary embodiment, the operating system 510 may be run on one or more cloud machine instances.

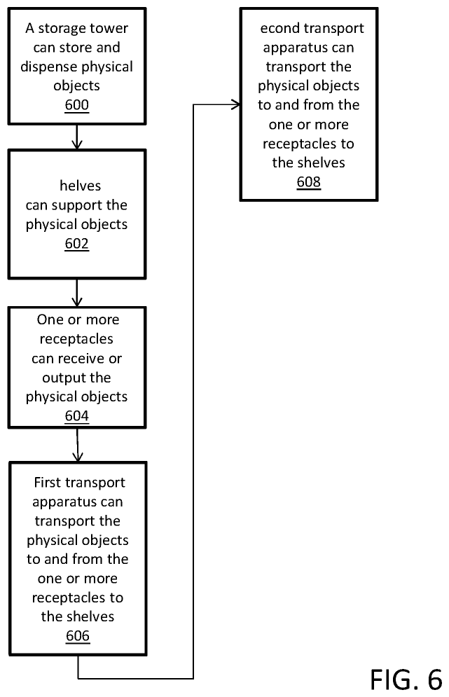

FIG. 6 is a flowchart illustrating a process of the autonomous storage and retrieval system according to exemplary embodiment. In operation 600, a storage tower (e.g., storage tower 100 as shown in FIGS. 1A-1B, 3, and 4) can store and dispense physical objects (e.g., physical objects 126, 128, 210 as shown in FIGS. 1A-2). In operation 602, shelves (e.g., shelves 156 as shown in FIG. 1B) disposed within the storage tower about a perimeter of an inner wall (e.g., interior wall 150 as shown in FIG. 1B) of the storage tower defining a central vertical cavity (e.g., central cavity 101 as shown in FIG. 1A) can support the physical objects. In operation 604, one or more receptacles (e.g., front, first side, and second side receptacle 112, 120, 116 as shown in FIGS. 1A-1B) can receive or output the physical objects to be stored by the storage tower or output from the storage tower. The one or more receptacles form one or more openings (e.g., front, first side, and second side openings 110, 118, 114 as shown in FIGS. 1A-1B) in the storage tower. In operation 606, a first transport apparatus (e.g., first transport apparatus 122 as shown in FIGS. 1A-1B, 4) operatively coupled to a first vertical shaft (e.g., first vertical shaft 123 as shown in FIGS. 1A-1B, 4) disposed in the central vertical cavity of the storage tower, can traverse and rotate about the first vertical shaft to transport the physical objects to and from the one or more receptacles to the shelves. In operation 608, a second transport apparatus (e.g., second transport apparatus 125 as shown in FIGS. 1A-1B, 4) operatively coupled to a second vertical shaft (e.g., second vertical shaft 130 as shown in FIGS. 1A-1B, 4) disposed in the central vertical cavity of the storage tower, can traverse and rotate about the second vertical shaft to transport the physical objects to and from the one or more receptacles to the shelves. The first and second transport apparatuses operate independently of each other.

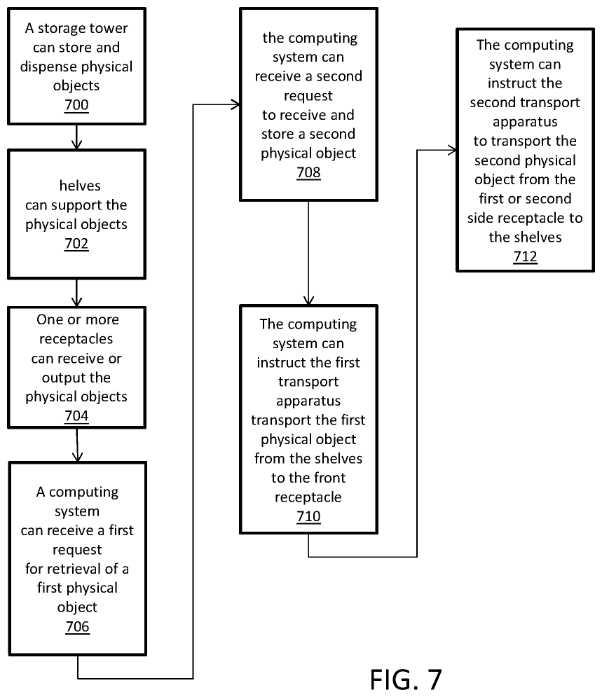

FIG. 7 is a flowchart illustrating the process of the autonomous storage and retrieval system according to exemplary embodiment. In operation 700, a storage tower (e.g., storage tower 100 as shown in FIGS. 1A-1B, 3, and 4) can store and dispense physical objects (e.g., physical objects 126, 128 as shown in FIGS. 1A-2). In operation 702, shelves (e.g., shelves 156 as shown in FIG. 1B) disposed within the storage tower about a perimeter of an inner wall (e.g., interior wall 150 as shown in FIG. 1B) of the storage tower defining a central vertical cavity can support the physical objects. In operation 704, one or more receptacles (e.g., front, first side, and second side receptacle 112, 120, 116 as shown in FIGS. 1A-1B) can receive or output the physical objects to be stored by the storage tower or output from the storage tower. The one or more receptacles form one or more openings (e.g., front, first side, and second side openings 110, 118, 114 as shown in FIGS. 1A-1B) in the storage tower. In operation 706, a computing system (e.g., computing system 400 as shown in FIG. 4) can receive a first request from the storage tower for retrieval of a first physical object (e.g., first physical object 126 as shown in FIGS. 1A-1B) stored in the storage tower through the front opening. In operation 708, the computing system can receive a second request from the storage tower to receive a second physical object (e.g., second physical object 128 as shown in FIGS. 1A-1B) for storage in the storage tower through a first or second side opening of the first or second side receptacle. In operation 710, the computing system can instruct the first transport apparatus (e.g., first transport apparatus 122 as shown in FIGS. 1A-1B, 4) to transport the first physical object from the shelves to the front receptacle. In operation 712, the computing system can instruct the second transport apparatus (e.g., second transport apparatus 125 as shown in FIGS. 1A-1B, 4) to transport the second physical object from the first or second side receptacle to the shelves.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step. Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

One or more of the exemplary embodiments, include one or more localized Internet of Things (IoT) devices and controllers. As a result, in an exemplary embodiment, the localized IoT devices and controllers can perform most, if not all, of the computational load and associated monitoring and then later asynchronous uploading of summary data can be performed by a designated one of the IoT devices to a remote server. In this manner, the computational effort of the overall system may be reduced significantly. For example, whenever a localized monitoring allows remote transmission, secondary utilization of controllers keeps securing data for other IoT devices and permits periodic asynchronous uploading of the summary data to the remote server. In addition, in an exemplary embodiment, the periodic asynchronous uploading of summary data may include a key kernel index summary of the data as created under nominal conditions. In an exemplary embodiment, the kernel encodes relatively recently acquired intermittent data (“KRI”). As a result, in an exemplary embodiment, KRI is a continuously utilized near term source of data, but KRI may be discarded depending upon the degree to which such KRI has any value based on local processing and evaluation of such KRI. In an exemplary embodiment, KRI may not even be utilized in any form if it is determined that KRI is transient and may be considered as signal noise. Furthermore, in an exemplary embodiment, the kernel rejects generic data (“KRG”) by filtering incoming raw data using a stochastic filter that provides a predictive model of one or more future states of the system and can thereby filter out data that is not consistent with the modeled future states which may, for example, reflect generic background data. In an exemplary embodiment, KRG incrementally sequences all future undefined cached kernels of data in order to filter out data that may reflect generic background data. In an exemplary embodiment, KRG incrementally sequences all future undefined cached kernels having encoded asynchronous data in order to filter out data that may reflect generic background data. In a further exemplary embodiment, the kernel will filter out noisy data (“KRN”). In an exemplary embodiment, KRN, like KRI, includes substantially a continuously utilized near term source of data, but KRN may be retained in order to provide a predictive model of noisy data.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

We claim:

1. An autonomous storage and retrieval system, the system comprising:
a storage tower configured to store and dispense a plurality of physical objects;
a plurality of shelves disposed within the storage tower about a perimeter of an inner wall of the storage tower defining a central vertical cavity, the plurality of shelves configured to support the plurality physical objects;
one or more receptacles for receiving the one or more physical objects to be stored by the storage tower or for outputting the one or more physical objects from the storage tower, the one or more receptacles forming one or more openings in the storage tower;
a first vertical shaft disposed in the central vertical cavity of the storage tower;
a first transport apparatus operatively coupled to the first vertical shaft, the first transport apparatus configured traverse the shaft to transport the plurality of physical objects to and from the one or more receptacles to the plurality of shelves;
a second vertical shaft disposed within the vertical central cavity of the storage tower and extending parallel to the first vertical shaft; and
a second transport apparatus operatively coupled to the second vertical shaft, the second transport apparatus configured traverse the second vertical shaft to transport the plurality of physical objects to and from the one or more receptacles to the plurality of shelves; and
wherein the first and second transport apparatuses operate independently of each other.

2. The system of claim 1, further comprising:
a computing system in communication with the storage tower.

3. The system of claim 2, wherein the one or more receptacles includes a first receptacle and a second receptacle, the one or more openings include a first opening formed by the first receptacle and a second opening formed by the second receptacle, and
wherein the first receptacle and the first opening are disposed on the upper half of the storage tower and the second receptacle and the second opening are disposed on lower half of the storage tower.

4. The system of claim 3, wherein the first transport apparatus is configured to traverse the first vertical shaft in the upper half of the storage tower and second transport apparatus is configured to traverse the second vertical shaft in the lower half of the storage tower.

5. The system of claim 4, wherein, the computing system is configured to:
receive a first request from the storage tower, for retrieval of a first physical object of the plurality of physical objects stored in the storage tower, through the first opening;
receive a second request from the storage tower to receive a second physical object of the plurality of physical objects for storage in the storage tower, through the second opening in the second receptacle;
instruct the first transport apparatus to transport the first physical object from at least one shelves of the shelving unit to the first receptacle;
instruct the second transport apparatus to transport the second physical object from the second receptacle to at least one of the shelves of the shelving unit for storage.

6. The system of claim 1, further comprising:
a first pair of rotatable plates disposed in an upper portion of the central cavity, the first vertical shaft being operatively coupled to a first plate in the first pair of rotatable plates and the second vertical shaft being operatively coupled to a second plate in the first pair of rotatable plates; and
a second pair of rotatable plates disposed in a lower portion of the central cavity, the first vertical shaft being operatively coupled to a third plate in the second pair of rotatable plates and the second vertical shaft being operatively coupled to a fourth plate in the second pair of rotatable plates;

7. The system of claim 6, wherein the first through fourth rotatable plates are circular members concentrically aligned about a rotational axis, the first and third plates are configured synchronously rotate and the second and fourth plates are configured to synchronously rotate, and the first and third plates are independently rotatable from second and fourth plates.

8. The system of claim 7, wherein the first vertical shaft is disposed a first radial distance from the rotational axis and the second vertical shaft is disposed at a second radial distance from the rotational axis.

9. The system of claim 7, wherein the first and second transport apparatuses extend radially from the first and second vertical shafts, respectively.

10. The system of claim 9, wherein the first and second transport apparatuses each are rotatable by the first and second vertical shaft, respectively to have three hundred sixty degree access to the shelves disposed about the central cavity.

11. An autonomous storage and retrieval method, the method comprising:
storing and dispensing, via a storage tower, a plurality of physical objects;
supporting, via a plurality of shelves disposed within the storage tower about a perimeter of an inner wall of the storage tower defining a central vertical cavity, the plurality physical objects;
receiving or outputting, one or more receptacles, the plurality of physical objects to be stored by the storage tower or from the storage tower, wherein the one or more receptacles forming one or more openings in the storage tower;
traversing, via a first transport apparatus operatively coupled to a first vertical shaft disposed in the central vertical cavity of the storage tower, the shaft to transport the plurality of physical objects to and from the one or more receptacles to the plurality of shelves;
traversing, via a second transport apparatus operatively coupled to a second vertical shaft disposed within the vertical central cavity of the storage tower and extending parallel to the first vertical shaft, the second vertical shaft to transport the plurality of physical objects to and from the one or more receptacles to the plurality of shelves,
wherein the first and second transport apparatuses operate independently of each other.

12. The method of claim 11, wherein a computing system is in communication with the storage tower.

13. The method of claim 12, wherein the one or more receptacles includes a first receptacle and a second receptacle, the one or more openings include a first opening formed by the first receptacle and a second opening formed by the second receptacle, and
wherein the first receptacle and the first opening are disposed on the upper half of the storage tower and the second receptacle and the second opening are disposed on lower half of the storage tower.

14. The method of claim 13, further comprising:
traversing, via the first transport apparatus, the first vertical shaft in the upper half of the storage tower; and
traversing, via the second transport apparatus, the second vertical shaft in the lower half of the storage tower.

15. The method of claim 14, further comprising:
receiving, via the computing system, a first request from the storage tower, for retrieval of a first physical object of the plurality of physical objects stored in the storage tower, through the first opening;
receiving, via the computing system, a second request from the storage tower to receive a second physical object of the plurality of physical objects for storage in the storage tower, through the second opening in the second receptacle;
instructing, via the computing system, the first transport apparatus to transport the first physical object from at least one shelves of the shelving unit to the first receptacle;
instructing, via the computing system, the second transport apparatus to transport the second physical object from the second receptacle to at least one of the shelves of the shelving unit for storage.

16. The method of claim 11, wherein:
a first pair of rotatable plates are disposed in an upper portion of the central cavity, the first vertical shaft is operatively coupled to a first plate in the first pair of rotatable plates and the second vertical shaft is operatively coupled to a second plate in the first pair of rotatable plates; and
a second pair of rotatable plates is disposed in a lower portion of the central cavity, the first vertical shaft is operatively coupled to a third plate in the second pair of rotatable plates and the second vertical shaft is operatively coupled to a fourth plate in the second pair of rotatable plates.

17. The method of claim 16, wherein the first through fourth rotatable plates are circular members concentrically aligned about a rotational axis, the first and third plates are configured synchronously rotate and the second and fourth plates are configured to synchronously rotate, and the first and third plates are independently rotatable from second and fourth plates.

18. The method of claim 17, wherein the first vertical shaft is disposed a first radial distance from the rotational axis and the second vertical shaft is disposed at a second radial distance from the rotational axis.

19. The method of claim 17, wherein the first and second transport apparatuses extend radially from the first and second vertical shafts, respectively

20. The method of claim 19, wherein the first and second transport apparatuses each are rotatable by the first and second vertical shaft, respectively to have three hundred sixty degree access to the shelves disposed about the central cavity.

21. An autonomous storage and retrieval system, the system comprising:
a storage tower configured to store and dispense a plurality of physical objects;
a plurality of shelves disposed within the storage tower about a perimeter of an inner wall of the storage tower defining a central vertical cavity, the plurality of shelves configured to support the plurality physical objects;
one or more receptacles for receiving the one or more physical objects to be stored by the storage tower or for outputting the one or more physical objects from the storage tower, the one or more receptacles forming one or more openings in the storage tower;
a first vertical shaft disposed in the central vertical cavity of the storage tower;
a first transport apparatus operatively coupled to the first vertical shaft, the first transport apparatus configured traverse the shaft to transport the plurality of physical objects to and from the one or more receptacles to the plurality of shelves;
a second vertical shaft disposed within the vertical central cavity of the storage tower and extending parallel to the first vertical shaft; and
a second transport apparatus operatively coupled to the second vertical shaft, the second transport apparatus configured traverse the second vertical shaft to transport the plurality of physical objects to and from the one or more receptacles to the plurality of shelves;
a first pair of rotatable plates disposed in an upper portion of the central cavity, the first vertical shaft being operatively coupled to a first plate in the first pair of rotatable plates and the second vertical shaft being operatively coupled to a second plate in the first pair of rotatable plates; and
a second pair of rotatable plates disposed in a lower portion of the central cavity, the first vertical shaft being operatively coupled to a third plate in the second pair of rotatable plates and the second vertical shaft being operatively coupled to a fourth plate in the second pair of rotatable plates,
wherein the first through fourth rotatable plates are circular members concentrically aligned about a rotational axis, the first and third plates are configured synchronously rotate and the second and fourth plates are configured to synchronously rotate, and the first and third plates are independently rotatable from second and fourth plates,
wherein the first and second transport apparatuses operate independently of each other.
